(19) United States
(12) Patent Application Publication
(10) Pub. No.: US 2007/0143088 A1
(43) Pub. Date: Jun. 21, 2007

(54) System and method for predicting biting insect conditions

(76) Inventor: Akhil Demian Garland, Harrisville, NH (US)

Correspondence Address: AKHIL D. GARLAND;P.O.BOX 134, 279 COBB HILL ROAD, HARRISVILLE, NH, 03450, US

(21) Appl. No.: 11/303,389

(22) Filed: Dec. 16, 2005

(51) Int. Cl. G06G 7/48; G06G 7/58

(52) U.S. Cl. 703/11

(57) ABSTRACT

A system uses not only current information but also historical information to determine and predict current and future insect activity. The system includes a processing unit which receives, as input, one or more factors such as current environmental information, date, time, user input, insect trap activity and perhaps weather information along with historical insect activity and associated environmental factors, to predict present and future insect activity. The system may include a display to show the user by geographic zone, the predicted insect activity level.

### FIELD OF THE INVENTION

This invention relates to biting insect prevention and more particularly, to a system and method for predicting when atmospheric and environmental conditions will likely be optimal for biting insect activity, which information can then be used to either issue a warning and/or to enable biting insect repellants or attractant traps.

### BACKGROUND

Flying insects have been bothering mankind since the beginning of time. Blood sucking biting insects are well known for causing deadly diseases such as Equine Encephalitis, wrecking outdoor picnics, ruining cocktail hours and sunsets, distracting golfers, driving gardeners indoors for protection, preventing homeowners from enjoying their pool or patio, and have in fact successfully created their own season in many areas of the world, widely known as “bug season.” But beyond the many inconveniences of biting insects are perilous dangers—biting insects are responsible for over one million deaths worldwide each year. Non-biting flying insects, such as house flies, fruit flies, etc. are also an annoyance and are known to carry and transmit diseases.

While the application on the skin of poison repellants, and the blanket, indiscriminate spraying of deadly poisons on geographic areas has been the method of choice for flying insect control for several decades, various contraptions have been developed over time to try and help manage flying insects (mosquitoes, black flies, gnats, horseflies, no-seeums, houseflies, etc) without the need for harmful pesticides. However none of these non-poisonous methods has been truly efficient and effective. For example electronic bug killing systems with ultraviolet light attraction sources have been proven effective at attracting and electrocuting non-biting flying insects such as moths, but have been proven ineffective at attracting and destroying biting insects. Individuals who are out of doors know to go inside if biting insects are active, as they are harassed or bitten by these insects. Individuals who are indoors and protected by the walls of their house or the screens on their doors and/or windows, however, do not know when it is safe to go outside. After many attempts to go outside only to be chased inside by the biting insects, individuals often find themselves indoors, reluctant to chance an outside experience.

Some weather predicting internet sites, such as www.weather.com have mosquito forecasts that predict the level of biting insect activity for a given zip code. It is believed that the predictor model only uses temperature and time of year to predict mosquito activity. The sites do not include forecasts for other biting insects, such as no-see-ums, horseflies, and black flies.

### SUMMARY OF THE INVENTION

The present t invention is a system that predicts current and future biting insect conditions for specific geographic locations, utilizing a combination of current and/or historical environmental conditions as well as current and/or historical levels of biting insect activity. The system includes a display or method of communicating to the user the predicted biting insect activity by zone. Zones can include different areas around a home or business, such as around a swimming pool, on a patio, in the front or back lawn, a swing-set, grilling area, etc. Each zone's physical characteristics are programmed into the system. The system can utilize artificial intelligence and, with user input, can learn from user experiences to better predict future conditions.

This instant invention comprises a sophisticated system managed by a computer that uses one or more current and forecasted environmental variables, including but not limited to current wind speed, wind direction, UV rating, rainfall, humidity, dew point, cloud cover, ambient light, barometric pressure combined with historical weather and biting insect activity to predict current and future biting insect activity.

It is important to note that the present invention is not intended to be limited to a system or method which must satisfy one or more of any stated objects or features of the invention. It is also important to note that the present invention is not limited to the preferred, exemplary, or primary embodiment(s) described herein. Modifications and substitutions by one of ordinary skill in the art are considered to be within the scope of the present invention, which is not to be limited except by the allowed claims.

### BRIEF DESCRIPTION OF THE DRAWINGS

These and other features and advantages of the present invention will be better understood by reading the following detailed description, taken together with the drawings wherein:

FIG. 1 is a block diagram of the system according to the present invention; and

FIG. 2 is a diagram of a display showing a selected geographic region with various zones in accordance with one aspect of the present invention.

### DETAILED DESCRIPTION OF THE PREFERRED EMBODIMENTS

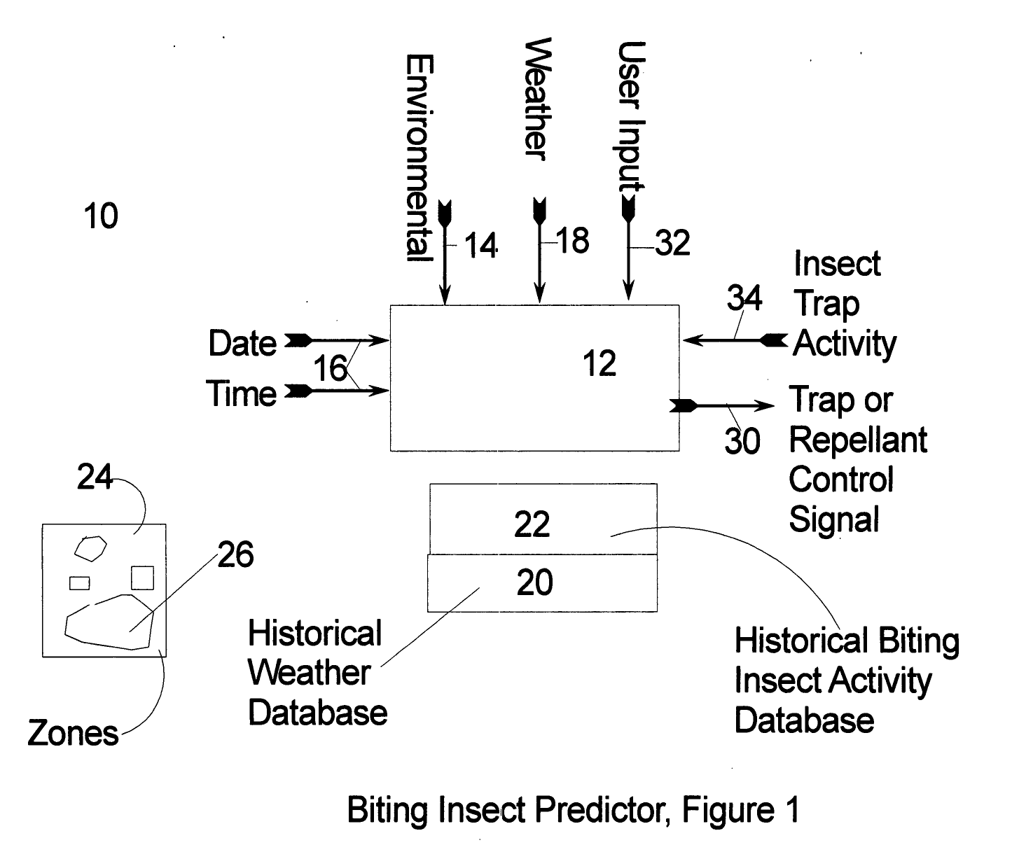

The present invention features a novel system 10, FIG. 1 and method for predicting current and future biting insect conditions for specific geographic locations, utilizing a combination of current and/or historical environmental conditions as well as current and/or historical levels of biting insect activity. A micro controller based computer 12 receives environmental or other relevant data 14 (either wirelessly or via wire), including current wind speed, wind direction, rainfall, outside temperature, humidity, barometric pressure, ultra-violet rays, cloud cover, ambient light, and uses this information, in combination with date and time 16 as well as forecasted weather information 18 (from a source such as the internet, weather service or the like) and historical weather information 20 and historical biting insect activity 22 stored in the system 10, to predict current and future biting insect activity for predefined zones. Other environmental related information which can be taken consideration is the unique physical characteristics of the zones or locations that are being predicted, such as the geographic location of shade-providing trees, bodies of water, streams, fields, mowed grass, buildings, wind barriers, stone walls, the height of a deck, etc.

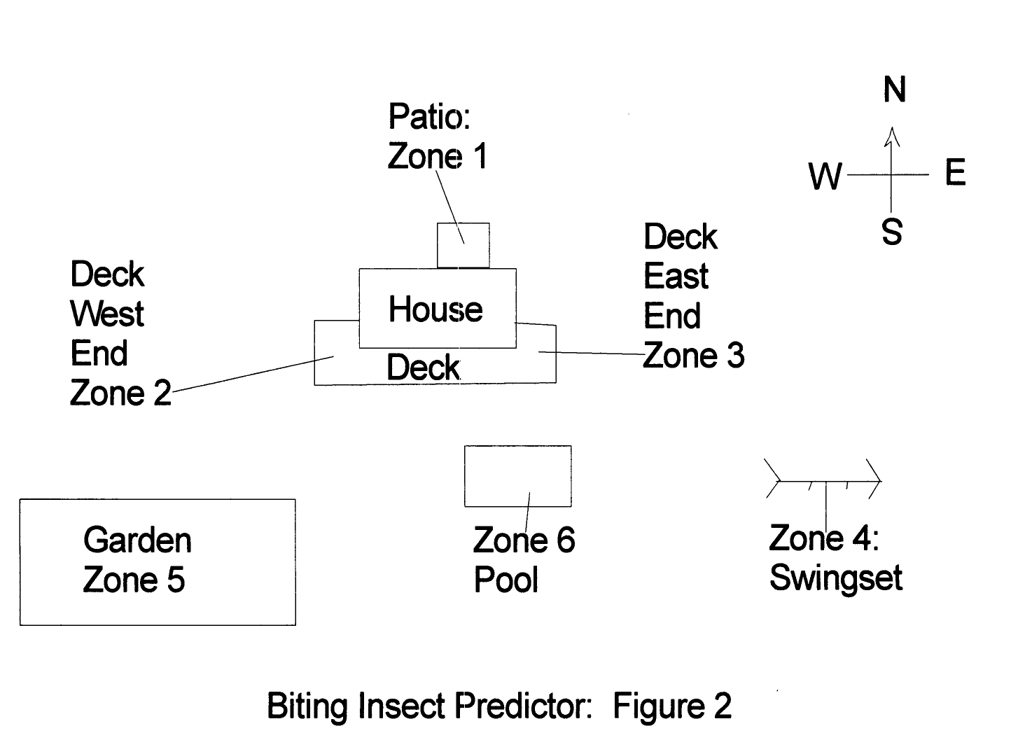

Zones are user-selectable and definable, and could comprise a swimming pool area, patio, porch, deck, hot-tub, flower garden, vegetable garden, golf green, swing set, grilling area, etc. Each zone can have its own environmental sensors 14 or there can be one environmental sensor and specific conditions of each zone are inferred from the readings of the one environmental sensor. Current and forecasted biting insect conditions are displayed on a computer-generated display 24, FIG. 2 or with different color light emitting diodes (not shown but within the skill of someone in the art, on a predefined map 26 of the predefined zones. For example, the system could use colored LED's and/or different shades of green, yellow, and red to communicate the intensity of biting insect activity. Each zone has it's own light. Each zone light could display a different color to communicate the level of activity in that zone. For example, green is best, yellow is proceed with caution, and red discourages the user from visiting this zone.

Environmental factors play a key role in predicting biting insect activity. Many biting insects, for example, will roost and are unlikely to feed in the event that the ambient air does not contain enough moisture, as it will dehydrate their wings and body. Many biting insects cannot fly in high wind conditions and are unable to feed on or pester humans. Many flying insects cannot fly if it is raining. Biting insects are much more active before an approaching storm, when the barometric pressure is falling quickly. Environmental conditions are ever changing, so this instant invention monitors these ever-changing conditions and produces one or more output signal 30 to operate a flying or biting insect attractant or repellant system according to the inputs it receives and the experiences it has previously learned. It is contemplated that the intelligent program and microprocessor (hereinafter controller) could be located remotely at a centralized service provider within a nearby town or as remote as another state or country, and specific controlling commands could be sent via the internet, or wirelessly via satellite, paging network, or other radio frequencies to this system. Of course, the controller could be located locally, on the premises to be protected.

This instant invention utilizes the unique concept of artificial intelligence, preset inputs (such as time, weather and environmental conditions) and user input 32. User input 32 is provided such that a user can report to the system a particular biting insect experience such as mosquito biting activity is extremely high and the system 10 will then utilize that input and information for future decision-making. For example, if the user is sunbathing at his or her swimming pool and is bothered by a biting insect such as a mosquito, the user can input this information into the system, which records the location of the experience (i.e. swimming pool area), date and time of the experience, along with other additional details, such as the type of biting insect that was annoying the user, the level of annoyance that the user experienced. The system then, using artificial intelligence, stores current environmental conditions along with the user's current experience and “learns” from this experience and utilizes it when predicting future biting insect conditions.

In another embodiment, this instant invention also utilizes the concept of monitoring the entry of biting insects into biting insect traps to count and predict current and future biting insect activity and conditions. Utilizing a biting insect trap such as a propane powered CO2 generating biting insect trap, the system, using optical or other mechanisms to count the entry of biting insects into the trap, can determine the current level of biting insect activity at different geographical locations. They system can then utilize this information 34 when predicting current and future biting insect activity in different zones.

Accordingly, the present invention provides a novel flying or biting insect controller which takes into account several conditions, both past and present, which conditions are relevant to predicting insect activity, and utilizes this information to control an insect attractant or repellant system. Although explained with regard to biting insects, this is not a limitation of the invention as flying insect and other insect behavior is also considered to be within the scope of the present invention.

As mentioned above, the present invention is not intended to be limited to a system or method which must satisfy one or more of any stated or implied object or feature of the invention and should not be limited to the preferred, exemplary, or primary embodiment(s) described herein. Modifications and substitutions by one of ordinary skill in the art are considered to be within the scope of the present invention, which is not to be limited except by the following claims.

What is claimed is:

1. A system for predicting current and future insect activity for specific geographic zone comprising:
a data base containing at least historical insect activity for a specific geographic zone, said historical insect activity including environmental conditions associated with said historical insect activity in said specific geographic zone; and
a processing unit, coupled to said database, for receiving at least said historical insect activity and said associated environmental conditions for said specific geographic zone, and for receiving as input at least current environmental information relative to said specific geographic zone, and responsive to said received historical insect activity and said current environmental information, for providing at least a display of predicted current and/or future insect activity for said specific geographic zone.

2. The system of claim 1 wherein said database includes historical weather information.

3. The system of claim 1 wherein said insect includes flying insects and biting insects.

4. The system of claim 1 wherein said processing unit receives two or more inputs selected from the group consisting of current environmental conditions, current weather, forecasted weather, user input, date, time, insect trap activity and unique physical characteristics of said specific geographic zone.

5. The system of claim 4 wherein said environmental conditions are monitored locally or inferred from commercially or publicly available current environmental conditions.

6. The system of claim 1 wherein said database includes known insect behavior as associated with certain environmental conditions.

7. The system of claim 1 wherein said environmental conditions include wind speed, wind direction, UV rating, rainfall, humidity, dew point, cloud cover, ambient light and barometric pressure.

8. The system of claim 1 wherein said user input includes insect experiences.

9. The system of claim 1 wherein said system predicts current and future insect activity by specific geographic zones.

10. The system of claim 1 further including a display device, coupled to said processing unit, for displaying current and/or predicted insect activity in a specific geographic zone.

11. The system of claim 1 wherein said processing unit receives as input, information concerning the relative numbers of insect entering one or more predetermined insect traps, and wherein said processing unit utilizes this information to predict current or future insect activity.

12. The system of claim 1 wherein said environmental conditions include unique physical characteristics of a specific geographic zone.

13. The system of claim 12 where said unique physical characteristics the geographic location of shade-providing trees, bodies of water, streams, fields, mowed grass areas, buildings, wind barriers, stone walls and the height of areas to be inhabited by humans.
